(19) United States
(12) Patent Application Publication
(10) Pub. No.: US 2025/0066639 A1
(43) Pub. Date: Feb. 27, 2025

(54) A SUPERHYDROPHOBIC COATING METHOD

(71) Applicant: TOBB EKONOMI VE TEKNOLOJI UNIVERSITESI, Ankara (TR)

(72) Inventors: Fatih BUYUKSERIN, Ankara (TR); Ibrahim Emre GULTAKTI, Ankara (TR)

(21) Appl. No.: 18/724,378

(22) PCT Filed: Dec. 27, 2022
(86) PCT No.: PCT/TR2022/051626

§ 371 Date: Jun. 26, 2024

(30) Foreign Application Priority Data
Dec. 28, 2021 (TR) 2021/021316

(51) Int. Cl. C09D 183/04; C09D 5/16; C09D 7/20; C09D 7/40

(52) U.S. Cl. CPC C09D 183/04; C09D 5/1681; C09D 7/20; C09D 7/67; C09D 7/68

(57) ABSTRACT

A superhydrophobic coating method used to make transparent and durable coatings that can be applied to glass, metal, textile, wood and polymeric surfaces with a single-stage spray in polymer/nano-particle composite structure.

### TECHNICAL FIELD

The present invention particularly relates to a superhydrophobic coating method, which can be applied with a single-stage spray in polymer/nano-particle composite structure, used to make transparent and durable coatings.

### PRIOR ART

Hydrophobia is defined as a surface avoiding interacting with water, or briefly water repellency. Whether a surface or a substance belongs to hydrophilic, hydrophobic or superhydrophobic types is understood by the contact angle between the water and the surface. Surfaces with a contact angle of less than ninety degrees with water are defined as hydrophilic surfaces, and surfaces with a contact angle of more than ninety degrees are defined as hydrophobic surfaces. The contact angle of superhydrophobic surfaces is above one hundred and fifty degrees and the slip (rolling) angles are below ten degrees. Water droplets making a surface wet, spreading of water droplets on the surface, or flowing from the surface without any interaction with the surface are the results of these situations. Examples of hydrophobia are observed in nature. For example, the contact angle of the leaves of the lotus flower (Nelumbo nucifera) is one hundred and sixty degrees. The contact angle of the lotus leaves causes the lotus to show hydrophobic behavior. Water droplets falling on the leaves of the lotus flower form droplets on the lotus and slide down to the ground. The floating water droplets also hold the dirt on the plant leaves. In this way, the leaves of the lotus plant are self-cleaning.

The hydrophobicity of a surface is desirable in some cases. For example, in the automotive industry, hydrophobic coatings are made to reduce pollution of vehicles and to protect vehicle paints. In another case, hydrophobic coatings are frequently used in the construction industry. The exterior of a building is often in contact with external factors. Factors such as rain, snow and dust pollute the exterior of the building and require repainting of the building over time. In this case, especially hydrophobic paints are preferred and the building is self-cleaning. In another case, hydrophobic coatings are frequently used in the glass-mirror industry. On the windshield of a vehicle that is moving in rainy weather, water droplets may accumulate on the glass, restricting the driver's vision and may cause accidents. In order to prevent this situation, transparent hydrophobic coatings are preferred on the windshields of vehicles. Thanks to the hydrophobic coatings, the water molecules falling on the glass slide off the glass as droplets and allow the driver to travel more safely. Hydrophobic coatings are frequently preferred in the automotive industry, textile industry, glass industry, furniture industry and paint industry.

Another reason why hydrophobic coatings are preferred is that they can be used as an anti-icing agent. In addition, in a different situation, hydrophobic coatings are used to delay corrosion. This delays the corrosion of metals used in environments with low pH values. Another reason why hydrophobic coatings are preferred is that they can be re-coated on the same surface. The aforementioned properties cause hydrophobic coatings to be preferred frequently.

Two important factors come to the fore when superhydrophobic surfaces are desired to be obtained artificially. The first important factor is that the surfaces on which hydrophobic coating is desired should be formed with a micro-nano-roughness layer. Another important factor is that the surface energy of the formed layer is lower than the surface energy of the water molecule. Chemicals such as alkyl and fluoro silanes, triols, fatty acids with long alkyl chains, and fluorinated polymers, hydrophobic silicones, organo-silicones are used to reduce the said surface energy. Especially silane chemicals are frequently preferred in researches and their costs are partially affordable.

In an embodiment in the state of the art, long carbon fluorinated silanes are used to obtain low surface energy. The long carbon fluorinated silane chemicals used in the said embodiment are toxic. For this reason, it is more appropriate to prefer fluorine-free production methods.

In another state-of-the-art embodiment, lithography, plasma, etching roughening and similar methods are used to create rough structures. In the said embodiment, the methods used are mostly used for research purposes. Advanced production techniques such as lithography, plasma, etching are difficult to be applied to industry.

In another part of the art embodiment, artificial superhydrophobic coatings do not meet the requirements in terms of durability and light transmission. It is observed that the impact-physical abrasion resistance of the superhydrophobic surfaces obtained in these embodiments is not sufficient for use in industrial applications. This situation causes the industrial application potentials of this embodiment to be limited.

In another application in the state of the art, there are some problems in embodiments where micro-nano particles are used to create surface roughness. The wear state on superhydrophobic surfaces is generally defined as the loss of the non-wetting property of the surface with the effect of increased adhesion between the water and the surface. One of the elements that ensures the said non-wetting is the micro-nano structured roughness formed on the surface. For this reason, the ability of these micro-nano particles not to break and their ability to adhere to the surface are the main factors that determine the strength of the said particles. In the mentioned embodiment, there are researches and embodiments for the use of heat resistant polymers such as thermoset and thermoplastic for better adhesion without breaking the particles and without deterioration of micro-nano roughness. However, embodiments where particle strengths are good and light transmission scale is good at the same time have not developed at an industrially adaptable level.

A superhydrophobic coating method is described in a Chinese Patent document numbered CN109575738 (A1), which is in the state of the art. The method in question is a method used for the same purpose as the present invention, but the method steps and the chemicals/materials used are different from the present application.

As explained above, hydrophobic coatings are frequently preferred in many industries, during and after production. Embodiments in the state of the art contain some problems. Long carbon fluorinated silane chemicals used to reduce the surface energy are toxic. For this reason, it should be preferred to reduce the surface energy with different materials. Another problem in the state of the art is that the methods used to create rough structures are not industrially applicable. Another problem in the state of the art is that the artificial superhydrophobic materials produced are eroded over time. These problems limit the production and life of superhydrophobic coatings. Solving the problems in the state of the art is extremely important to increase the usage areas and usable times of superhydrophobic coatings.

Thanks to the present invention, a superhydrophobic coating method that can be easily used in industry, can be adapted to the desired surface by spray method, is transparent, has high strength and is easy to manufacture, is realized.

### OBJECTS OF THE INVENTION

The object of this invention is to realize a superhydrophobic coating method that provides superhydrophobic (high water repellency) at “water contact angle >150°, low shear angle <10°” on surfaces made of glass, textile, metal, ceramic, wood and polymer materials.

Another object of the present invention is to provide a spray coating method that can be applied in one step, and to realize an industrially applicable superhydrophobic coating method that is easy to produce.

Another object of the present invention is to provide a transparent and durable superhydrophobic coating method wherein toxic chemicals such as fluorocarbons or various silane chemicals are not used to obtain surface roughness, and surface roughness is formed with nanoparticles produced easily and cheaply with PDMS polymer, which is frequently preferred in the industry, and surface energy is reduced.

Another object of the present invention is to realize a superhydrophobic coating method that does not cause the appearance and color of the applied surface to change, thanks to its transparent feature, and preserves its transparency, especially in areas where surface appearance is important.

Another object of the present invention is to realize a highly durable superhydrophobic coating, which has improved adhesion to the applied surface and can stay in the applied area for a longer period of time.

### BRIEF DESCRIPTION OF THE INVENTION

This invention is used to impart high strength and transparent superhydrophobic properties to the applied surface and is particularly suitable for industrial use.

The superhydrophobic coating method, which is the subject of the application, is formed by preparing a solution containing nano-particles and polymers, applying the prepared solution to a surface and curing on the surface.

In its most basic form, a superhydrophobic coating method as defined in the first claim and other claims dependent on this claim, realized in order to achieve the aim of the present invention, comprises: providing nano-particle production, drying and pulverizing the produced nano-particles, preparing a suspension in which polymer material is added and the main solvent is preferably alcohol; preparing a solution of polymer and curing agent; preparation of the main solution by adding the polymer solution to the prepared suspension, adding the curing agent to the main solution, applying the produced suspension to a surface and curing.

The superhydrophobic coating method of the invention is obtained as a result of performing the above-mentioned steps in sequence. Nanoparticles are produced to impart the superhydrophobic property. Preferably, the silica nanoparticles are obtained using the sol-gel method. The nano-particles produced in the sol-gel method are synthesized and precipitated in the liquid in which they are synthesized with the help of centrifugation.

In order to partially control the agglomeration mechanism, the nano-particles precipitated by centrifugation are preferably dried at 30% humidity between 23° and 27°, covered with parafilm and allowed to breathe with small pores. The nanoparticles are then crushed into powder.

The powdered nanoparticles, preferably isopropyl alcohol, are combined in a container and a suspension is prepared. A solution is prepared with the polymer and polymer solvent in a different container/bottle. The main solution is formed by adding polymer solvent to the prepared suspension.

Curing agent, preferably half the weight of the polymer used, is added dropwise into the main solution and the main solution is left for a while. The created suspension is ready for application.

The suspension is preferably applied to the desired surface with the help of a spray. After application to the surface, preferably between six and twenty-four hours, the solution cures on the surface. In this way, a superhydrophobic coating method with high strength and transparent properties, which is the subject of the invention, is realized.

### DETAILED DESCRIPTION OF THE INVENTION

A “superhydrophobic coating method” performed to achieve the purpose of the present invention is shown in the attached figures, which are;

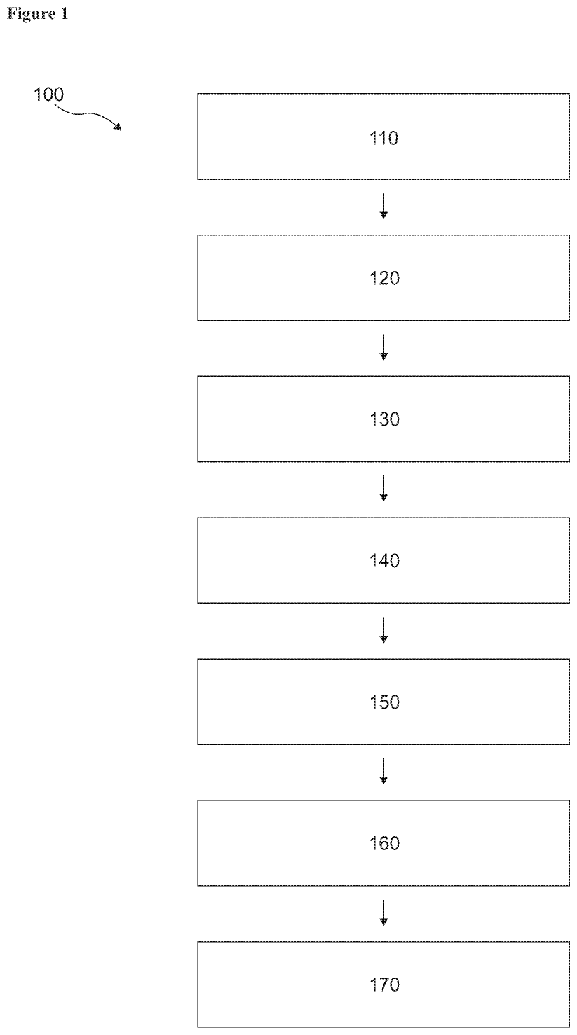

FIG. 1. The subject of the invention is the flow chart of the steps of the superhydrophobic coating method.

The steps of the superhydrophobic coating method, which is the subject of the invention, are numbered one by one, and the equivalents of these numbers are given below.
100. Superhydrophobic coating method
110. Nano-particle production
120. Drying and pulverizing nano-particles
130. Preparation of suspension
140. Solution preparation
150. Preparation of the main solution
160. Addition of curing agent
170. Application and curing of the suspension to a surface

A transparent and high-strength superhydrophobic coating method (100) according to the present invention, in its most basic form, comprises:
providing nano-particle production (110),
drying and pulverizing the produced nano-particles (120),
preparation of a suspension by adding the produced nanoparticles into the main solvent, preferably alcohol (IPA, Ethyl alcohol, etc.), (130)
preparation of the polymer and polymer solvent solution (140)
preparation of the main solution (150) by adding the polymer solution to the prepared suspension (130),
adding the curing agent to the main solution (160),
applying the produced suspension to a surface and curing (170).

A superhydrophobic coating method (100) of the invention has been developed in order to impart superhydrophobic properties to the surfaces in question by applying it to the desired surfaces. The biggest advantage of the method in question is that the coating strength is high without affecting the transparency too much.

One of the steps performed for a superhydrophobic coating method (100) of the invention is nano-particle production (110). In the preferred embodiment of the invention, silica nanoparticle is preferred as nanoparticle. Silica is a cheap, non-toxic, and easy to control chemical, so silica nanoparticle is preferred.

In the preferred embodiment of the invention, nano-particle production (110) is carried out using the Stöber method, preferably with the infrastructure of the sol-gel method. Silica nanoparticles are synthesized in a basic medium. For this reason, nanoparticles are precipitated in order to obtain nanoparticles at the last stage of production. In the said embodiment, centrifuge is used to precipitate the nanoparticles.

In a superhydrophobic coating method (100) of the invention, the dimensions of the nanoparticles produced have a critical effect for the invention. In the nano-particle production step (110), the dimensions of the particles are between 20 nm and 70 nm, with an average size of 39.5 nm. Increasing the size of the nanoparticle causes the nanoparticle to scatter light more and this reduces the transparency of the superhydrophobic coating method (100) of the invention.

In the preferred embodiment of the invention, the method step of nano-particle production (110) is as follows; first, a glass bottle is washed and dried with distilled water, 0.1 M sodium hydroxide (NaOH) and technical ethanol, respectively. The next step following this step is filling 20 mL of 99.99% pure ethyl alcohol (—C2H5OH) into the cleaned glass bottle, and then adding 0.9 mL of ammonium hydroxide (NH4OH) therein, and mixing for 15 minutes with the help of magnetic fish in a magnetic stirrer at 800 rpm. Then, before feeding the silica source tetraethylorthosilicate (TEOS) (SiC₈H₂₀O₄) to the alcohol solution, the mixing speed is reduced to 270 rpm and 0.5 mL of TEOS is added dropwise to the solution, and the process is left to stir for 18 hours at room temperature in an environment where there is no light. After 18 hours, the nanoparticles synthesized in the solution are precipitated at 12000 rpm with the help of a mini-centrifuge in 2 mL epondorfs. As a result of this step, the nano-particle is synthesized and the production is completed (110).

Drying and pulverizing the produced nano-particles (120) is done such that after centrifugation in a glass bottle or at 30% humidity at room temperature for 18 hours, it would be directly inside the ependorf or falcon tubes, and its mouth would be parafilmed and small holes would be opened to allow air to enter. The obtained silica nanoparticles were pulverized (120).

Another step performed for a superhydrophobic coating method (100), which is the subject of the invention, is the preparation of a suspension (130), the main solvent of which is alcohol, by adding nano-particles into it. In the said embodiment, different types of alcohols such as ethyl alcohol, isopropyl alcohol can be used. In the preferred embodiment of the invention, IPA (Isopropyl Alcohol) is used as the main solvent alcohol. IPA (Isopropyl alcohol) is a compound with the chemical formulas C₃H₈O, C₃H₇OH or CH₃CHOHCH₃. IPA is colorless and flammable. In the suspension preparation stage, the amount of nanoparticles used is such that they constitute 0.1% to 10% of the total suspension weight.

In a preferred embodiment of the invention, in the step of preparing a suspension (130) by adding nanoparticles therein with the main solvent as alcohol, silica nanoparticles at between 0.5% and 1% by weight of the total suspension, were placed in a glass bottle of suitable volume and subjected to sonication and vortexing in isopropyl alcohol. The purpose of said sonication and vortex processes is to obtain a homogeneous silica nanoparticle distribution in isopropyl alcohol. For this reason, the duration of the said sonication and vortexing processes is applied until the suspension has a homogeneous distribution. In the preferred embodiment of the invention, the suspension is preferably sonicated for one hour and vortexed for five minutes in the suspension preparation step (130).

Another step performed for a superhydrophobic coating method (100) of the invention is the preparation of the polymer and polymer solvent solution (140). At this stage, siloxane-derived polymers can be used in this step because of their properties. The amount of polymer used in the said step is in the ratios between these values, including preferably 1/2 to 1/30 by weight of the nano-particles used. In the solution preparation stage, a solvent is used to dissolve the polymer. Solvents such as THF (Tetrahydrofuran) and Toluene can be used as solvents.

In the preferred embodiment of the invention, PDMS (Polydimethylsiloxane) containing methyl group as polymer and THF (Tetrahydrofuran) as solvent are preferred. There are a number of reasons why PDMS polymer is preferred in the step of preparing the polymer and polymer solvent solution (140). PDMS polymer is preferred because it is transparent, hydrophobic, inexpensive, non-toxic and compatible with nanoparticles. PDMS is preferred because it adheres well to the glass material, is compatible with nano-particles, and has hydrophobic properties in its structure. PDMS provides the strength of the superhydrophobic coating method (100) of the invention.

In the preferred embodiment of the invention, the step 140 of preparing the polymer and polymer solution is as follows. PDMS (Polydimethylsiloxane) polymer is used in such a way that its weight ratio is preferably one third of the weight ratio of silica nanoparticles (PDMS/Silica nanoparticle=1/3). The PDMS polymer used is mixed in THF (Tetrahydrofuran) solvent for about 15 minutes using a magnetic stirrer.

Another step performed for a superhydrophobic coating method (100) of the present invention is adding a solution of nano-particles (130), polymer and polymer solution (140) into the prepared suspension and preparing the mother solution (150). At this stage, the nanoparticles are mixed with a solution of polymer and curing agent, preferably in a ratio of 1/2 to 1/30 of the weight of the nanoparticles.

In the preferred embodiment of the invention, an amount of THF (Tetrahydrofuran) solution, preferably 1/3 of the silica nano-particle ratio by weight, was added to the IPA (Isopropyl alcohol) suspension containing silica nano-particles. The said solution was preferably left to stir at 800 rpm with a magnetic stirrer at room conditions for 24 hours (150).

Another step performed for a superhydrophobic coating method (100) of the invention is the addition of the curing agent (160) to the main solution. The curing agents used to perform the curing process in the said step are added to the main solution. The amount of PDMS curing agent to be used in this step is preferably 10 to 60% by weight of the PDMS polymer used. After adding the PDMS curing agent to the main solution, it is mixed and left to stand.

In the preferred embodiment of the invention, the PDMS curing agent is half of the amount of PDMS in the main solution (PDMS curing agent/PDMS polymer=1/2). In the said embodiment, the PDMS curing agent is added dropwise to the main solution. The main solution to which the curing agent was added was sonicated, preferably for 2 hours. Said main solution was preferably mixed in a magnetic stirrer for 6 hours and the main solution was prepared for application by spray.

Another step performed for a superhydrophobic coating method (100) of the invention is applying the produced suspension to a surface and curing (170). With this step, the main solution is applied to the surface that wants to gain superhydrophobic feature and the applied solution is cured for a certain period of time. As a result of these processes, superhydrophobic properties are given to the coated surfaces.

In the preferred embodiment of the invention, the suspension produced is applied to the surface using the spray method and cured (170). In the said embodiment, the amount of spraying is tried to be kept at the optimum value. The large amount of solution applied by spraying causes a decrease in the transparency of the solution. If the amount of solution applied by spraying is low, the strength of the coating is low and its service life is reduced. In order to achieve a more efficient curing, curing is performed for at least 6 hours, preferably 24 hours, in the said embodiment.

With a superhydrophobic coating method (100), which is the subject of the invention, water “contact angle >150°, low shear angle <10°” features are provided to the desired surfaces. With these features, a desired surface has high water repellency, does not get wet, and in case of water contact, the surface is cleaned by taking the solid particles on the surface with it.

In a different embodiment of the invention, TiO₂, ZnO, MgO veya Ca₁₀(PO₄)₆(OH)₂) nanoparticles are used. In the said embodiment, TiO₂ (Titanium dioxide), ZnO (Zinc oxide), MgO (Magnesium oxide) or Ca₁₀(PO₄)₆(OH)₂) (Hydroxyapatite) is produced (110) at the nano-particle production stage (110).

The operation of a superhydrophobic coating method (100) subject to the invention in an embodiment is as follows. Nanoparticle production is carried out using appropriate materials and tools (110). The nanoparticles produced are then dried and pulverized (120). A suspension is prepared using nanoparticles, in which polymer material is added, and the main solvent is preferably alcohol (130). A solution of polymer and curing agent is prepared in a different environment (140). The main solution is prepared (150) by adding the nanoparticle, polymer and curing agent solution (140) into the prepared suspension (130). In the next step, the curing agent is added to the main solution (160). The main suspension to which the curing agent is added is applied to a surface and cured for a period of time (170). The curing process is carried out at a temperature of 100° to 200° (170). By performing all these steps sequentially and correctly, a superhydrophobic coating method (100) is performed, which gives superhydrophobic property to the applied surface.

1. A superhydrophobic coating method (100) used to impart superhydrophobic property to a surface, and having high strength and transparent feature, the method comprising the following steps:
providing nano-particle production using a silica source tetramethylorthosilicate (TMOS), tetraethylorthosilicate (TEOS) (SiC₈H₂₀O₄) with dimensions preferably between 10 nm and 500 nm, more preferably between 15 nm and 250 nm, most preferably between 20 nm and 70 nm with optimized agglomeration mechanisms to preserve transparency (110);
nano-particles, which are precipitated by centrifugation, being dried at a humidity of approximately 30%, between 23° and 27° temperature such that it is covered with parafilm and allowed to breathe through small pores, in order to partially control the agglomeration mechanism;
drying the produced nano-particles at room temperature and pulverizing them (120);
preparation of a suspension by adding the produced nanoparticles into alcohol (130), the main solvent being alcohol;
preparation of a solution by mixing the siloxane type polymer material with transparent properties, which reduces the surface energy and provides strength, and a polymer solvent that is a member of the ether group, in a separate container (140);
preparation of the main solution by adding the solution containing the polymer and the polymer solvent to the suspension containing the nano-particle and alcohol (150);
adding the curing agent suitable for the polymer used into the prepared main solution (160); and
applying the produced suspension to a surface and curing for at least six hours (170).

2. The superhydrophobic coating method (100) according to claim 1, wherein silica nano-particles are produced using the sol-gel method in the nano-particle production step (110).

3. (canceled)

4. The superhydrophobic coating method (100) according to claim 13, characterized by precipitation, with the help of centrifugation, of silica nanoparticles produced by sol-gel method in the nano-particle production step (110).

5. The superhydrophobic coating method (100) according to claim 1, characterized by production of one of the TiO₂, ZnO, MgO, or Ca₁₀(PO₄)₆(OH)₂) nano-particles in the nano-particle production (110) step.

6. The superhydrophobic coating method (100) according to claim 1, wherein the nano-particles are dried at room temperature for at least one hour, under at least 1% humidity conditions in the step of drying and pulverizing the nano-particles (120).

7. The superhydrophobic coating method (100) according to claim 6, characterized by pulverization of the nano-particles produced in the step of drying and pulverizing the nano-particles (120).

8. The superhydrophobic coating method (100) according to claim 1, the main solvent being alcohols preferably using ethyl alcohol or IPA (isopropyl alcohol) or ethyl alcohol as the main solvent in the step of preparing a suspension (130) by adding nano-particles therein.

9. The superhydrophobic coating method (100) according to claim 1, the main solvent being alcohol and the amount of nano-particles used in the step of preparation of suspension (130) by adding nanoparticles therein constituting preferably 0.1% to 50%, more preferably 0.2% to 30%, most preferably % 0.3 to % 2 of the total suspension weight.

10. The superhydrophobic coating method (100) according to claim 1, the main solvent being alcohol and the amount of nanoparticles used in the step of preparation of suspension (130) by adding nanoparticles therein constituting 0.5% to 2% of the total suspension weight.

11. The superhydrophobic coating method (100) according to claim 1, wherein polymer, in the amount of between preferably 1/1 and 1/30, more preferably 1/2 and 1/10 by weight of the nano-particles used in the step of preparing polymer and polymer solvent solution (140), being used.

12. The superhydrophobic coating method (100) according to claim 1, wherein PDMS (Polydimethylsiloxane) comprising methyl group as the polymer is used in the step of preparing polymer and polymer solvent solution (140).

13. The superhydrophobic coating method (100) according to claim 1, wherein the amount of PDMS (Polydimethylsiloxane) used in the step of preparing the polymer and polymer solvent solution (140) is one third of the weight of the nanoparticles.

14. The superhydrophobic coating method (100) according to claim 1, wherein THF (Tetrahydrofuran) or Toluene are used as the polymer solvent in the step of preparing polymer and polymer solvent solution (140).

15. The superhydrophobic coating method (100) according to claim 1, comprising adding, in the step of preparation of the main solution (150), THF (Tetrahydrofuran) solution, preferably 1/3 of the silica nano-particle ratio by weight, to the IPA (Isopropyl alcohol) or ethyl alcohol suspension comprising silica nano-particles, and mixing the suspension with a magnetic stirrer at 800 rpm for at least one hour at room condition.

16. The superhydrophobic coating method (100) according to claim 1, comprising using curing agent in the rate of 10% to 60% by weight of the polymer used in the step (160) of adding the curing agent to the main solution.

17. The superhydrophobic coating method (100) according to claim 16, comprising adding curing agent to the main solution at the rate of 1/2 by weight of the PDMS polymer used, in the step of adding curing agent to the main solution (160).

18. The superhydrophobic coating method (100) according to claim 1, comprising performing curing operation at 100° to 200° for at least six hours or at least 24 hours at room temperature, in the step of applying the produced suspension to a surface and curing (170).
